(19) United States
(12) Patent Application Publication
(10) Pub. No.: US 2024/0175716 A1
(43) Pub. Date: May 30, 2024

(54) METHOD, SYSTEM AND COMPUTER PROGRAM PRODUCT FOR ASCERTAINING A YAWRATE OFFSET VALUE

(71) Applicant: Valeo Schalter und Sensoren GmbH, Bietigheim-Bissingen (DE)

(72) Inventor: Akram Ghadieh, Bietigheim-Bissingen (DE)

(73) Assignee: Valeo Schalter und Sensoren GmbH, Bietigheim-Bissingen (DE)

(21) Appl. No.: 18/552,436

(22) PCT Filed: Mar. 23, 2022
(86) PCT No.: PCT/EP2022/057580

§ 371 Date: Sep. 25, 2023

(30) Foreign Application Priority Data
Mar. 25, 2021 (DE) 10 2021 107 520.3

(51) Int. Cl. G01C 25/00; G01C 19/00

(52) U.S. Cl. CPC G01C 25/00; G01C 19/00

(57) ABSTRACT

The invention relates to a method for ascertaining a yaw-rate offset value (ωoffset) which represents the offset of yaw-rate measurement values of a yaw-rate sensor (2) of a motor vehicle (1). The method has the following steps: receiving (100) a plurality of yaw-rate measurement values (ω1, . . . , ωx) from the yaw-rate sensor (2) over time (t), said measurement values constituting a yaw-rate measurement signal (Sω); checking (200) whether the motor vehicle (1) is at a standstill; and if so, ascertaining (500) the yaw-rate offset value (ωoffset) on the basis of the yaw-rate measurement signal (Sω). The method is characterized by the steps of ascertaining (300) yaw-rate measurement values (Gst) which form a slope (St) in the yaw-rate measurement signal (Sω); and disregarding (400) the ascertained yaw-rate measurement values (Gst) which form a slope (St) in order to ascertain (500) the yaw-rate offset value (ωoffset).

The invention relates to a method for ascertaining a yaw-rate offset value, which represents the offset of yaw-rate measurement values of a yaw-rate sensor of a motor vehicle. The invention also relates to a method for ascertaining a yaw-rate value. Ascertaining the yaw-rate offset value or the yaw-rate value can also be understood to mean estimating the same. The invention also relates to a corresponding control device for ascertaining a yaw-rate offset value and/or a yaw-rate value, a corresponding sensor device for a motor vehicle, a corresponding computer program product, and a corresponding motor vehicle.

Many vehicle systems or driver assistance systems require a reliable yaw rate (or yaw-rate value) as input variable or input value for their calculations, e.g. for locating the motor vehicle, determining the orientation of the motor vehicle, estimating the self-motion of the motor vehicle, etc. The accuracy of the yaw rate of a yaw-rate sensor, in particular a gyroscope, is mainly influenced by two factors: the bias and the drift (or measurement distortion) over time and/or temperature.

The commonly used method of compensating for this inaccuracy is to ascertain or estimate the yaw-rate offset value when the vehicle is either moving in a straight line in a first scenario, or stationary in a second scenario. Such a method is disclosed in DE 10 2018 115 28 A1, for example. In both the first and the second scenario, the assumption is made that the vehicle has a theoretical yaw rate of 0°/s. The commonly used method then takes an offset value into account when ascertaining the yaw rate and corrects the last yaw-rate value accordingly.

EP1264749 B1 discloses a method for compensating a system for measuring the yaw rate of a motor vehicle, wherein the system comprises a yaw-rate sensor and low-frequency components of the signal are filtered out of the yaw-rate sensor signal. If the filtered signal does not exceed a predetermined magnitude in a predetermined time interval, the system is matched to the signal present at the sensor output at an instant at the end of the time interval.

DE 19736199 A1 discloses an estimation device for a neutral point, comprising a first detection unit that detects the fact that a rotational movement of the automobile is being executed. A second detection unit detects a convergence of the values of a derivative of a yaw speed, which are obtained from the output signals of a yaw-rate sensor. A detection unit for a neutral point determines a neutral point of the yaw-rate sensor by means of an output signal of the yaw-rate sensor when the convergence of the values of the yaw-rate derivative is detected by the second detection unit after the first detection unit detects that the rotational movement is being executed. In DE 19736199 A1, a rectilinear movement of the vehicle is ascertained on the basis of the output signal of the yaw-rate sensor.

Document U.S. Pat. No. 9,193,382 B2 describes a method for calculating the offset of a yaw-rate signal, which may be at least partially based on signals representing the drive wheel angle, wheel speed, and yaw rate. These signals can be determined and threshold comparisons can be carried out, and the determination of the yaw-rate signal can be based at least partially on the results of the threshold comparisons.

Document DE 10 2018 115 28 A1 relates to a method for ascertaining an offset value for an inertial measurement unit, wherein the offset value refers to a stationary motion state of a motor vehicle. A first set of measurement values is acquired at a first instant using the inertial measurement unit. The first set of measurement values includes a measurement value for a steering angle of one axis of the motor vehicle and a plurality of measurement values for a rotation speed of one or more wheels of the motor vehicle. The first set of measurement values is then used to check whether the stationary motion state of the motor vehicle is present. At a second instant, a second set of measurement values is acquired in the same way as at the first instant. The second set of measurement values is used to check again whether the stationary motion state of the motor vehicle is present. An offset value is ascertained for the inertial measurement unit as a function of the first and second sets of measurement values and as a function of the stationary motion state of the motor vehicle. In DE 10 2018 115 28 A1, the stationary motion state of the motor vehicle is characterized by a standstill or a movement of the motor vehicle in a straight line at a constant speed.

It has now been found that a problem occurs when the motor vehicle is stationary but rotating about its own axis. In this case, the yaw rate is greater than 0°/s. This scenario can occur, for example, when the vehicle is on a turntable. In this case, the measured yaw-rate value is not an offset, but rather an actual measurement value.

Such a turntable is currently used, for example, in public parking lots, e.g. mostly in Japan, or privately for houses or their driveways, for example in the USA. Such a turntable can be used in particular when there is little maneuvering space or in spatially confined conditions. The turntable thus rotates the vehicle with minimal maneuvering space.

Current systems or methods from the prior art estimate or determine the yaw-rate offset value when the vehicle is stationary. The systems or methods in the prior art do not take into account or detect whether the vehicle is on a rotating turntable. This will result in an inaccurate estimate of the yaw-rate offset value for such a case where the vehicle is positioned on a rotating turntable.

The object of the present invention is to provide a method, a control device, a sensor device, a computer program product and a motor vehicle, which can be used to more reliably determine a yaw-rate offset value or a yaw-rate value.

This object is achieved by way of a method, a control device, a computer program product, and a motor vehicle in accordance with the independent claims.

The invention relates to a method for ascertaining (or estimating) a yaw-rate offset value, which constitutes the offset of yaw-rate measurement values of a yaw-rate sensor of a motor vehicle. The method comprises the following steps: receiving a plurality of yaw-rate measurement values from the yaw-rate sensor over time, which constitute a yaw-rate measurement signal; checking whether the motor vehicle is stationary; and if so, ascertaining the yaw-rate offset value based on the yaw-rate measurement signal.

According to the invention, the method now comprises the following steps: ascertaining yaw-rate measurement values that form a slope in the yaw-rate measurement signal; and disregarding the yaw-rate measurement values that form a slope in order to ascertain the yaw-rate offset value. These steps can be carried out in particular in or before the step of ascertaining the yaw-rate offset value. The step of disregarding can also be understood as removing and/or filtering out the yaw-rate measurement values that form a slope. Thus, these values are not used for ascertaining or estimating the yaw-rate offset value.

By ascertaining yaw-rate values that form or have a slope in the yaw-rate measurement signal, it is possible to detect, in a manner of speaking, whether the motor vehicle is on a rotating turntable. If the yaw-rate measurement values form or have a slope, it can be concluded that the motor vehicle is on a rotating turntable at that moment (when the motor vehicle is at a standstill). These yaw-rate measurement values do not constitute a yaw-rate offset, but are rather actually measured yaw-rate values. These should therefore be disregarded or removed when ascertaining the yaw-rate offset value.

By ascertaining yaw-rate measurement values which form a slope in the yaw-rate measurement signal, it can thus be detected whether the motor vehicle, although stationary, is located on a turntable. If it is detected that the motor vehicle is located on a turntable, the step of disregarding or removing the ascertained yaw-rate measurement values that form or have a slope is carried out to determine the yaw-rate offset value. To ascertain the yaw-rate offset value, therefore, only the yaw-rate measurement values of the part of the yaw-rate measurement signal are used, in which the motor vehicle is stationary but not rotating. This results in a more accurate determination or estimation of the yaw-rate offset value.

Yaw-rate measurement values that form a slope can be ascertained, for example, with a statistical procedure. In particular, yaw-rate measurement values which form a slope can be ascertained by forming a (simple) linear regression with or over the yaw-rate measurement values or a subset thereof. The slope of the straight line thus ascertained can then be checked (e.g. whether it is steep enough), in particular whether this slope exceeds a slope threshold value (e.g. slope >5%). It is then possible to check which of the yaw-rate measurement values (e.g. from the subset) belong to this slope. These yaw-rate measurement values, which belong to the slope, are then disregarded. The other yaw-rate measurement values that do not belong to the slope can then be used in ascertaining the yaw-rate offset value. This type of slope determination can also be performed with limited storage space and/or computation time and therefore does not require excessive resources. However, other known types of slope determination are of course also possible.

A further aspect of the invention relates to a method for ascertaining (or estimating) a yaw-rate value, comprising the steps of the method for ascertaining a yaw-rate offset value, in particular according to an aspect or embodiment in this description. The method also comprises ascertaining a yaw-rate value or the yaw rate based on the yaw-rate measurement signal (or the yaw-rate measurement values(s) over time) and the yaw-rate offset value ascertained.

The method therefore uses the ascertained yaw-rate offset value to determine the yaw-rate value or the yaw rate. The yaw-rate value or the last or current actually measured yaw-rate value ωᵣₑₐₗ can then be adjusted using the yaw-rate offset value ω_{offset}. This allows the yaw-rate value or yaw rate ω to be ascertained. This can be carried out according to the following formulas:

ω(t)=ωᵣₑₐₗ+ω_{offset}(t) [1]

with: ω_{offset}(t)=Bias+Drift(t) [2].

It has been found that a problem occurs if at the time the yaw-rate offset value is ascertained, i.e. here in formula [2], the vehicle is at a standstill but rotating about its own axis (or (vertical) vehicle axis). In this case, the yaw rate is greater than 0°/s. This scenario can occur, for example, when the vehicle is on a turntable. This problem is remedied by the method according to the invention for ascertaining the yaw-rate offset value.

For example, a turntable can be a vehicle turntable or a driveway turntable. Such a turntable is a rotary (or rotatable) disk (or plate) that is designed to rotate a vehicle located on it, in particular about its own (vertical) axis. Such a turntable may be in particular a circular-shaped disk or plate on which the motor vehicle can be moved about its own (vertical) axis. The turntable therefore rotates about its axis when the motor vehicle is stationary on it. Such a turntable is usually mounted on the ground or recessed in it. Such a turntable may be located in a driveway or garage, or may be mounted on the ground of the driveway or garage, or recessed in it. The turntable can be rotated or turned manually or by motorized means. The aim or benefit of such a turntable is usually a simplified and/or safer exit or maneuvering of a motor vehicle out of its driveway or garage.

In one embodiment the step of checking whether the motor vehicle is stationary comprises checking whether a speed of the motor vehicle is equal to or approximately zero and/or wheel pulses of the motor vehicle are equal to or approximately zero. In particular, it can be checked here whether the delta pulses from all wheels of the motor vehicle are equal to or approximately zero for a predetermined debouncing time (e.g. at least or approximately 400 ms).

In one embodiment, the method may comprise, in particular, comparing the yaw-rate measurement signal (or the plurality of yaw-rate measurement values) with a threshold value. In particular, each yaw-rate measurement value can be compared individually with the threshold value. The threshold value can have, in particular, a value of approximately or a maximum of 3°/s, in particular approximately or a maximum of 2.5°/s, in particular approximately 1°/s. In particular, the yaw-rate measurement values below the threshold may include the yaw-rate measurement values when the turntable begins to rotate or stops rotating.

Only a set or group of permissible yaw-rate measurement values is thus analyzed. These can also be referred to as relevant yaw-rate measurement values. In order for a yaw-rate measurement value to be valid or relevant, it must be within a predetermined range. This is checked by means of the threshold value, in particular checking that the values are below the threshold value. This range or threshold value can be a predetermined or configured value, in particular depending on the particular yaw-rate sensor. However, it is not sufficient for the yaw-rate measurement value to be only within a range or below a threshold value. A yaw-rate measurement value may be below a threshold value but may be part of the turning or rotating motion of the turntable (in particular if the turntable starts to turn or stops turning) and therefore may not be valid for ascertaining the yaw-rate offset value. Therefore, according to the invention, the yaw-rate measurement values that form a slope in the yaw-rate measurement signal are ascertained and are disregarded or filtered out to ascertain the yaw-rate offset value. In particular, if enough (filtered) values are available or stored in a memory, the yaw-rate offset value can be ascertained.

In one embodiment, the method may comprise ascertaining relevant yaw-rate measurement values of the yaw-rate measurement signal which are below the threshold value. In particular, for each yaw-rate measurement value, it can be ascertained individually whether it is below the threshold value. If this is the case, this yaw-rate measurement value can be classified or stored as a relevant yaw-rate measurement value. Therefore, only the possible valid or relevant yaw-rate measurement values are considered for ascertaining the yaw-rate offset value.

The method may comprise, in particular, storing the ascertained yaw-rate measurement values that are below the threshold value in a memory, in particular a ring buffer (e.g. maximum buffer length 20). The method may in particular comprise checking whether a sufficient number of ascertained yaw-rate measurement values are stored in the memory (e.g. between 10 and 20 values, or exactly 20 or 10 values). Whether a sufficient number of ascertained yaw-rate measurement values are stored in the memory depends in particular on the update rate of the yaw-rate measurement values or the yaw-rate measurement signal or the corresponding software routine or the software module for ascertaining the yaw-rate offset value or the yaw-rate value. For example, with an update rate of approximately 40 ms, 10 values in the memory may be a sufficient number. At an update rate of approximately 20 ms, e.g. 20 values in the memory may be a sufficient number.

In one embodiment, the step of ascertaining yaw-rate measurement values which form a slope in the yaw-rate measurement signal can be carried out on the basis of the ascertained relevant yaw-rate measurement values which are below the threshold value. It is also possible to check whether there are enough yaw-rate measurement values available (e.g. in the memory) to measure a slope.

In one exemplary embodiment, ascertaining yaw-rate measurement values that form a slope in the yaw-rate measurement signal may comprise forming a (simple) linear regression with or over the yaw-rate measurement values, in particular the yaw-rate measurement values in the memory or the most recent yaw-rate measurement values in memory (e.g. the last 3-4 yaw-rate measurement values in memory). In particular, the relevant yaw-rate measurement values ascertained that are below the threshold value can be used for this purpose. The slope of the straight line thus ascertained can then be checked (e.g. whether it is steep enough), in particular whether this slope exceeds a slope threshold value (e.g. slope >5%). It is then possible to check which of the yaw-rate measurement values, in particular those in the memory, belong to this slope. These yaw-rate measurement values, which belong to the slope, are then disregarded. The other yaw-rate measurement values that do not belong to the slope can then be used in ascertaining the yaw-rate offset value.

In one embodiment, the disregarding of the ascertained yaw-rate measurement values that form a slope may comprise removing (or filtering out) these values which are below the threshold value from the relevant yaw-rate measurement values. Only the remaining yaw-rate measurement values can then be used for determining the yaw-rate offset value. In other words, the yaw-rate measurement values that form a slope are not used to ascertain the yaw-rate offset value.

In particular, disregarding the ascertained yaw-rate measurement values that form a slope may comprise removing the values from the memory. In particular, it can be checked whether a sufficient number of ascertained yaw-rate measurement values are stored in the memory (e.g. between 10 and 20 values, or exactly 20 or 10 values). It can thus be checked whether sufficient yaw-rate measurement values are or remain present in the memory to calculate the yaw-rate offset value subsequently.

In particular, the yaw-rate offset value can be ascertained by means of the yaw-rate measurement values remaining (in the memory). In particular, the remaining yaw-rate measurement values can be the yaw-rate measurement values (in the memory) which result from the relevant yaw-rate measurement values after deducting or disregarding or removing the ascertained yaw-rate measurement values that form a slope. The remaining yaw-rate measurement values can in particular be denoted by Gᵥₑᵣ=Gᵣₑₗ−G_{St}, where Gᵣₑₗ indicates the relevant yaw-rate measurement values (below the threshold value), and G_{St} the yaw-rate measurement values that form a slope.

In one embodiment, ascertaining the yaw-rate offset value may include ascertaining the mean value of the remaining yaw-rate measurement values. The mean value can be calculated in particular as the quotient of the sum of the remaining yaw-rate measurement values and the number of the remaining yaw-rate measurement values. This can be carried out in particular based on the following formula:

ω_{offset}=SUM(Gᵥₑᵣ)/N [3]
with Gᵥₑᵣ=Gᵣₑₗ−G_{St}: yaw-rate measurement values remaining
   N: number of yaw-rate measurement values remaining

In one embodiment, the method comprises checking the plausibility of the ascertained yaw-rate offset value. In one embodiment, the plausibility checking may comprise checking whether the (modulus or absolute) yaw-rate offset value ascertained is within a defined range. The range can be in particular within approximately (plus/minus) 0.6°/s or less, in particular approximately (plus/minus) 0.3°/s. For example, a typical (absolute) yaw-rate offset value can be in the defined range of 0.2 to 0.3°/s.

Another aspect of the invention relates to a control device for ascertaining a yaw-rate offset value, which is designed to carry out the method for ascertaining the yaw-rate offset value according to one of the aspects or embodiments in this description. A further aspect of the invention relates to a control device for ascertaining a yaw-rate value, which is designed to carry out the method for ascertaining the yaw-rate value (or yaw rate) according to one of the aspects or embodiments in this description.

Another aspect of the invention relates to a sensor device for a motor vehicle, having at least one yaw-rate sensor, in particular a gyroscope, and having a control device according to one of the aspects or embodiments in this description.

The control device and/or the sensor device may be in particular in the form of or part of a driver assistance system, in particular for assisting a driver of the motor vehicle and/or for the semiautonomous or fully autonomous operation of the motor vehicle. The control device and/or the sensor device (or the driver assistance system) may be designed in particular, inter alia, for locating the motor vehicle, determining the orientation of the motor vehicle, and/or estimating the self-movement of the motor vehicle. The control device and/or the sensor device (or the driver assistance system) may be designed for operation at higher speeds, e.g. for semi-autonomous or fully autonomous driving of a motor vehicle. Alternatively or cumulatively, the control device and/or the sensor device (or the driver assistance system) can also be designed for operation at low speeds, e.g. for parking and/or maneuvering.

A further aspect relates to a computer program product having program code means that are stored in a computer-readable medium in order to carry out the method according to an aspect or embodiment in this description, when the computer program product is run on a processor of an electronic control unit. In particular, the computer program product can be implemented on a processor of the control unit and processed there.

A further aspect relates to a motor vehicle having a sensor device according to an aspect or embodiment in this description. The motor vehicle can be in the form of an automobile or a commercial vehicle.

Advantageous forms of embodiment of the method are to be viewed as advantageous forms of embodiment of the control device, the sensor device, the computer program product, and the motor vehicle. For this purpose, the control device, the sensor device, the computer program product and the motor vehicle have specific features that allow the method and an advantageous embodiment thereof to be carried out.

Further features of the invention can be gathered from the claims, the figures and the description of the figures, The features and combinations of features that are cited in the description above, and also the features and combinations of features that are cited in the description of the figures below and/or as shown in the figures alone, can be used not only in the respectively indicated combination but also in other combinations or on their own without departing from the scope of the invention. Therefore, such embodiments of the invention are also to be considered as comprised and disclosed as are not explicitly shown or explained in the figures, but which emerge from and can be generated from the embodiments described by the separate feature combinations. Embodiments and combinations of features that therefore do not have all the features of an originally formulated independent claim should also be regarded as disclosed.

Furthermore, designs and combinations of features, in particular those of the designs described above, which go beyond or differ from the feature combinations set out in the cross-references of the claims, shall also be considered to be disclosed.

Exemplary embodiments of the invention will be discussed in more detail below on the basis of schematic drawings.

in which:

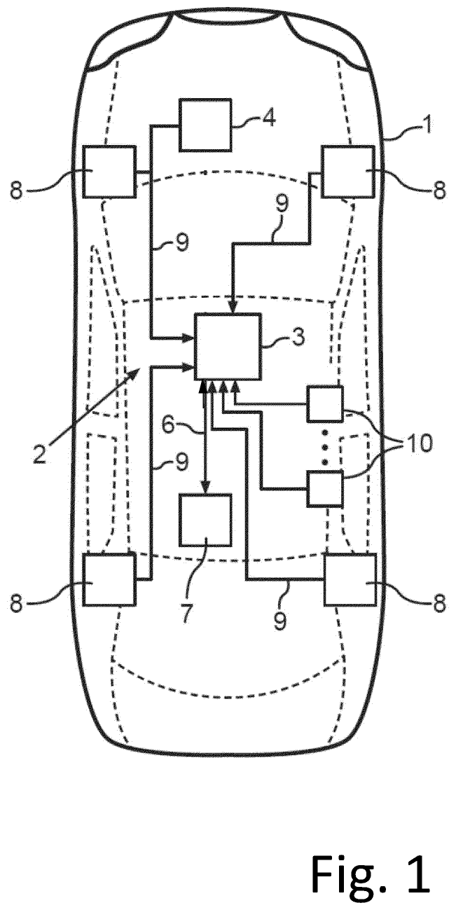

FIG. 1 shows a schematic plan view of an exemplary embodiment of a motor vehicle with an embodiment of a sensor device;

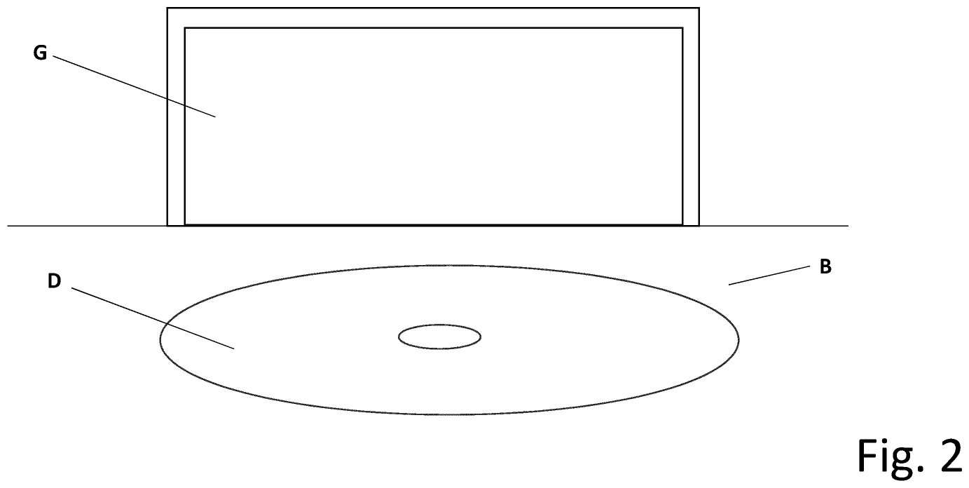

FIG. 2 shows a schematic view of a turntable in front of a garage;

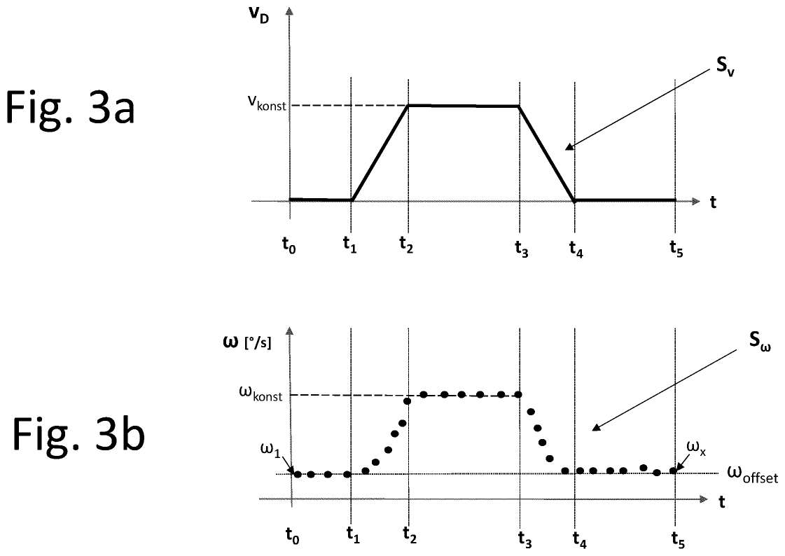

FIG. 3a shows a diagram of an exemplary turntable speed signal over time,

FIG. 3b shows a diagram of an exemplary yaw-rate measurement signal corresponding to the exemplary turntable speed of FIG. 3a;

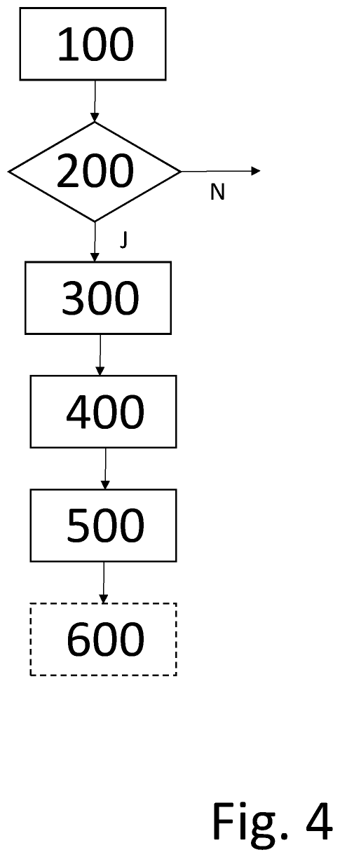

FIG. 4 shows a schematic flow diagram of an exemplary embodiment of the method for ascertaining the yaw-rate offset value;

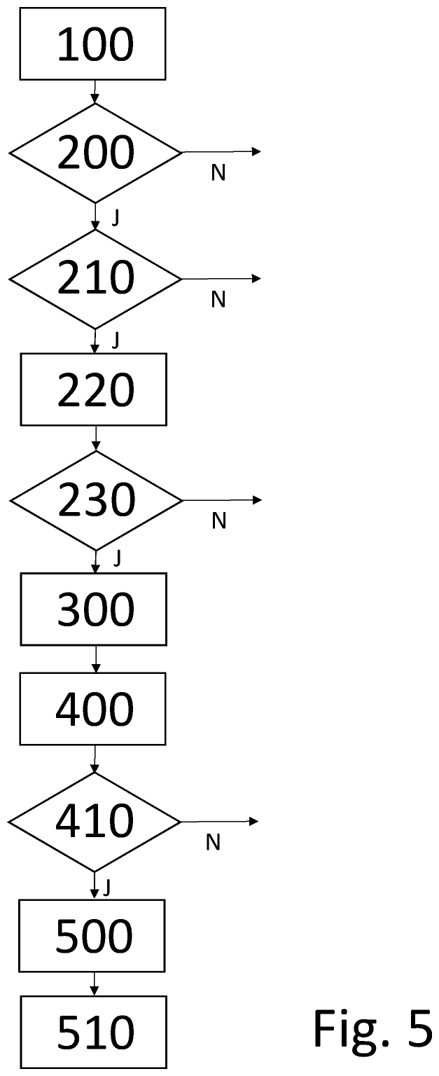

FIG. 5 shows a schematic flow diagram of another exemplary embodiment of the method for ascertaining the yaw-rate offset value or the yaw-rate value;

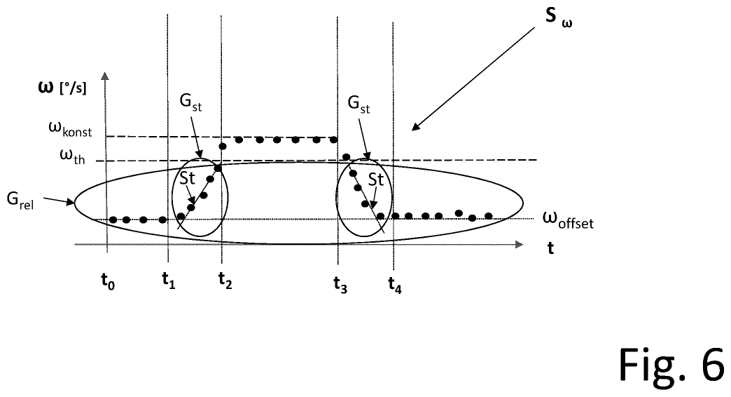

FIG. 6 shows a diagram of another exemplary yaw-rate measurement signal;

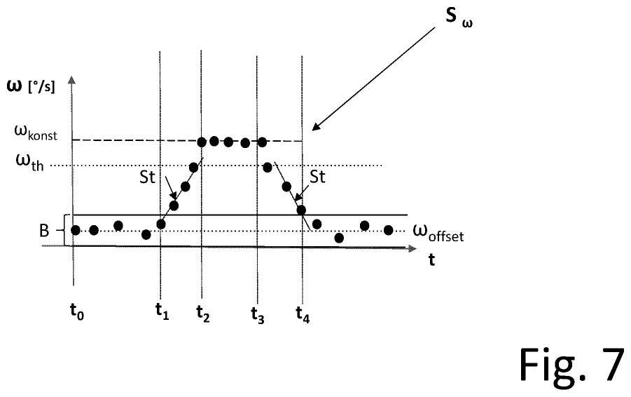

FIG. 7 shows a diagram of an exemplary yaw-rate measurement signal of a further exemplary embodiment; and

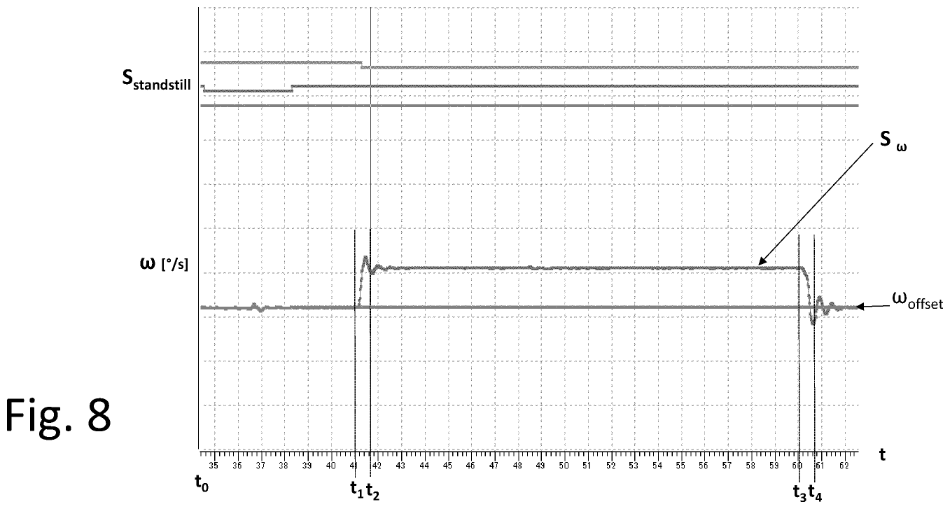

FIG. 8 shows a diagram of an actually measured yaw-rate measurement signal of a further exemplary embodiment.

The same reference signs are given in the figures to identify elements that are identical and have the same functions.

FIG. 1 shows a schematic plan view of an exemplary embodiment of a motor vehicle 1 with an embodiment of a sensing device 2. The motor vehicle 1 is designed in the present exemplary embodiment as a passenger car. The motor vehicle 1 includes a sensor device 2, e.g. in the form of or part of a driver assistance system. The sensor device 2 or the driver assistance system is designed in particular to assist a driver of the motor vehicle 1. Further, the sensor device 2 or the driver assistance system may also be designed for semi-autonomous or fully autonomous operation of the motor vehicle 1. In particular, the sensor device 2 or the driver assistance system can then control corresponding components of the motor vehicle 1 so that a partially autonomous or a fully autonomous operation can be carried out by the controller of the sensor device 2 or by the driver assistance system. The sensor device 2 or the driver assistance system may be designed for operation at higher speeds, e.g. for semi-autonomous or fully autonomous driving of the motor vehicle 1. Alternatively or cumulatively, the sensor device 2 and/or the driver assistance system can also be designed for operation at low speeds, e.g. for parking and/or maneuvering.

The sensor device 2 comprises a yaw-rate sensor 4, in particular gyroscope, and a control device 3. The control device 3 is designed to carry out the method described below for ascertaining a yaw-rate offset value or yaw-rate value. The yaw-rate sensor 4 is connected to the control device 3 via a line 9 (e.g. a vehicle bus). The control device 3 can receive a yaw-rate measurement signal S_{ω} or a plurality of yaw-rate measurement values from the yaw-rate sensor 2 via the line 9. The yaw-rate measurement signal S_{ω} of the yaw-rate sensor 4 is thus transmitted via the line 9 to the control device 3. The transmission via the line 9 can be wireless and/or wired.

The control device 3 in this exemplary embodiment is further coupled to wheel sensors 8, which are mounted on the wheels of the motor vehicle 1 and provide so-called wheel pulses, which characterize the revolutions of the wheels. Multiple pulses can be generated per revolution. In this exemplary embodiment, the wheel sensors 8 are also connected to the control device 3 via the line 9 (e.g. vehicle bus). Alternatively, they can also be connected via a different line. The control device 3 in FIG. 1 can also receive the wheel pulses via the line 9. The wheel pulses of the wheel sensors 8 are thus transmitted to the control device 3 via the line 9.

In this exemplary embodiment shown in FIG. 1, the control device 3 is further coupled to a steering and/or drive device 7. Here, the control device 3 is connected via a line 5 to the steering and/or drive device 7. The control device 3 can transmit control signals to the steering and/or drive device 7 via the line 5, e.g. to control the steering angle and/or the longitudinal guidance of the motor vehicle 1 by means of the steering device and/or to accelerate and/or decelerate the motor vehicle 1 automatically by means of the drive device.

In this exemplary embodiment of FIG. 1, the control device 3 additionally receives sensor data from environmental sensors 10. The environmental sensors 10 may be designed, for example, for detecting objects and/or obstacles in the surroundings of the motor vehicle 10, for example as ultrasonic sensors and/or radar sensors and/or optical distance sensors and/or cameras.

The sensor device 2 may also comprise further sensors, such as a longitudinal acceleration sensor (not shown) for detecting the longitudinal acceleration of the motor vehicle 1.

Furthermore, the control device 3 has a computer program product, which has program code means stored in a computer-readable medium to be able to carry out the method described below for ascertaining the yaw-rate offset value or yaw-rate value. In particular, the computer program product is implemented on a processor of the electronic control unit 3 and is processed there.

The sensor device 2 and/or the driver assistance system requires a reliable yaw rate as an input variable for calculations carried out in the control device 3, e.g. for locating the motor vehicle 1, determining the orientation of the motor vehicle 1, and/or estimating the self-motion of the motor vehicle 1. It is therefore important to have a reliable method for ascertaining the yaw rate or a yaw-rate value (as an input variable for the subsequent calculations in the control device 3), in particular in the control device 3. In a conventional method for ascertaining the yaw rate ω, a real yaw-rate value ωᵣₑₐₗ of the yaw-rate sensor 4 (or the latest or current actually measured yaw-rate value) is adjusted by means of an ascertained yaw-rate offset value ω_{offset}.

It has been found that a problem occurs if at the time the yaw-rate offset value is ascertained, the motor vehicle 1 is at a standstill but rotating about its own axis, or vertical vehicle axis (in FIG. 1 therefore, the axis out of the drawing plane or perpendicular to the drawing plane). In this case, the yaw rate is greater than 0°/s. This scenario can occur, for example, when the motor vehicle 1 is on a turntable. This problem is remedied by a method for ascertaining the yaw-rate offset value, which is described below.

As an illustrative example of such a situation, FIG. 2 shows a schematic view of a turntable D in front of a garage G. The turntable D here is a vehicle turntable or a driveway turntable in front of the garage G. The turntable D is implemented as a rotatable (or turning) disk or plate, which is designed to allow the motor vehicle 1, for example from the exemplary embodiment of FIG. 1, to turn on it, in particular about its own axis or vertical axis. The turntable D is here a circular-shaped disk or plate on which the motor vehicle 1 can be turned around about its own axis or vertical axis. The turntable D thus rotates about its axis when the motor vehicle 1 is stationary on it. Here, turntable D is mounted on or recessed in the ground B. In this exemplary embodiment, the turntable is thus arranged in front of a garage G or in a driveway, or mounted on or recessed in the ground B of the driveway. The turntable D can be rotated or turned manually or by motorized means. The aim or benefit of such a turntable D is usually a simplified and/or safer exit or maneuvering of the motor vehicle 1 out of the driveway or garage. In the exemplary embodiment of FIG. 2, the turntable D may be arranged in the driveway of a house, i.e. on private property, or else in a public parking lot, i.e. in a public space. Such a turntable D can be used in particular when there is little maneuvering space or in spatially confined conditions. The turntable D thus rotates the motor vehicle 1 in the minimum necessary maneuvering space.

FIG. 3a shows a diagram of an exemplary turntable speed signal Sᵥ against time t. It is assumed that a motor vehicle 1 is located on the turntable D. The speed v_{D} of the turntable D is shown on the y-axis and the time t on the x-axis. In the period from time point t₀ to t₁, the turntable is stationary, i.e. the turntable speed v_{D} is zero. In the period from time point t₁ to t₂, the turntable speed v_{D} increases linearly or at a constant rate, i.e. the turntable D starts to rotate or accelerates about its own axis. Likewise, the vehicle 1 on the turntable D is then accelerated about the vehicle vertical axis. In the period t₂ to t₃, the turntable D rotates at a constant turntable speed vₖₒₙₛₜ. In the period from time point t₃ to t₄, the turntable speed v_{D} decreases linearly or at a constant rate, i.e. the turntable D stops rotating or decelerates. Likewise, the vehicle 1 on the turntable D is then decelerated in its movement about the vertical axis of the vehicle. After the time t₄ (up to the time of the end of the measurement period t₅), the turntable D, and thus also the vehicle 1 located on it, is stationary again.

FIG. 3b now shows the corresponding diagram of the exemplary yaw-rate measurement signal S_{ω} of the yaw-rate sensor 4 of the sensor device 2 of the motor vehicle 1. The exemplary yaw-rate measurement signal S_{ω} of FIG. 3b is thus shown for, or corresponding to, the exemplary turntable speed v_{D} of FIG. 3a. The yaw-rate measurement signal S_{ω} is also plotted against the time t. The yaw rate or yaw-rate measurement values ω in units °/s are shown on the y-axis and the time t on the x-axis. The plurality of yaw-rate measurement values ω₁, . . . , ωₓ, which are received or come from the yaw-rate sensor 2, over the time t form the yaw-rate measurement signal S_{ω} or constitute it. In the period from time t₀ to t₁, the turntable and thus also the vehicle 1 is stationary. Accordingly, the yaw-rate value measured here corresponds approximately to the yaw-rate offset value ω_{offset}. This therefore represents the offset of the yaw-rate measurement values of the yaw-rate sensor 4 of the motor vehicle 1. In the period from time t₁ to t₂, the turntable speed v_{D} then increases linearly or at a constant rate, i.e. the turntable D starts to rotate or accelerates about its own axis. Likewise, the vehicle 1 on the turntable D is then accelerated about the vehicle vertical axis. Thus, in the period from time t₁ to t₂, the yaw-rate measurement values also increase in their value, i.e. form a positive slope. In the period t₂ to t₃, the turntable D, and accordingly also the vehicle 1, rotates at a constant turntable speed. In the period t₂ to t₃, the yaw-rate measurement values also have an approximately constant value ωₖₒₙₛₜ, which is, however, far above the yaw-rate offset value ω_{offset} of the yaw-rate sensor 4. In the period from time t₃ to t₄, the turntable speed v_{D} decreases linearly or at a constant rate, i.e. the turntable D stops rotating or decelerates. Likewise, the vehicle 1 on the turntable D is then decelerated in its movement about the vertical axis of the vehicle. Thus, in the period from time t₃ to t₄, the yaw-rate measurement values also decrease in value, i.e. form a negative slope. After the time t₄ (up to the time of the end of the measurement period t₅), the turntable D, and thus also the vehicle 1 located on it, is stationary again. The yaw-rate measurement values now correspond approximately to the yaw-rate offset value ω_{offset}. If a conventional method for ascertaining the yaw-rate offset value were then applied to the entire yaw-rate measurement signal S_{ω} of FIG. 3b, for example by averaging, i.e ascertaining the average value of the entire yaw-rate measurement signal S_{ω} from time t₀ to time t₅, this would result in an incorrect yaw-rate offset value. This is because the yaw-rate measurement values in the period from time t₁ to t₄ do not constitute a yaw-rate offset, but rather are actually measured yaw-rate values. These should therefore not be used when ascertaining the yaw-rate offset value. A corresponding reliable method for ascertaining the yaw-rate offset value ω_{offset} will now be described below.

FIG. 4 shows a schematic flow diagram of an exemplary embodiment of the method for ascertaining the yaw-rate offset value ω_{offset}, which represents the offset of yaw-rate measurement values of the yaw-rate sensor 4 of a motor vehicle 1. The method comprises a first step 100 of receiving a plurality of yaw-rate measurement values ω₁, . . . , ωₓ from the yaw-rate sensor 2 over time t, said measurement values constituting a yaw-rate measurement signal S_{ω}. The first step 100 is then followed by a step 200 of checking whether the motor vehicle 1 is stationary. The checking in step 100 may comprise checking whether a speed v_{Ego} of the motor vehicle 1 is equal to or approximately zero. Alternatively or cumulatively, it may comprise checking whether the wheel pulses of the motor vehicle 1, for example of the wheel sensors 8, are equal to or approximately zero.

If it is now decided in FIG. 4 in step 200 that the motor vehicle 1 is not stationary (branch N for “No” in FIG. 4), the method for ascertaining the yaw-rate offset value ends at this point. However, a method for ascertaining the yaw-rate offset value for rectilinear motion can then also be used, for example.

If it is now decided in FIG. 4 in step 200 that the motor vehicle 1 is stationary (branch Y for “Yes” in FIG. 4), then the method continues and a step 500 of ascertaining 500 the yaw-rate offset value ω_{offset} based on the yaw-rate measurement signal S_{ω} is subsequently carried out. Before or in the step 500 of ascertaining the yaw-rate offset value, however, the following steps must then be carried out: firstly, the step 300 of ascertaining yaw-rate measurement values Gₛₜ which form a slope St in the yaw-rate measurement signal S_{ω}, and secondly, the step 400 of disregarding the ascertained yaw-rate measurement values Gₛₜ which form a slope St, for or in the step 500 of ascertaining the yaw-rate offset value ω_{offset}. This step 400 of disregarding can also be understood as removing and/or filtering out the yaw-rate measurement values Gₛₜ that form a slope St. Thus, these values Gₛₜ are not used to determine or estimate the yaw-rate offset value ω_{offset}.

By the step 500 of ascertaining the yaw-rate measurement values Gₛₜ which form a slope St in the yaw-rate measurement signal S_{ω}, it can thus be quasi detected whether the motor vehicle 1 is located on a rotating turntable D. If the yaw-rate measurement values form or have a slope St, it can be concluded that the motor vehicle 1 is on the rotating turntable at that moment (while the motor vehicle 1 is stationary). These yaw-rate measurement values Gₛₜ do not constitute a yaw-rate offset, but are rather actually measured yaw-rate values. These should therefore be disregarded or removed when ascertaining the yaw-rate offset value.

By the step 400 of ascertaining yaw-rate measurement values Gₛₜ which form a slope St in the yaw-rate measurement signal S_{ω}, it can thus be detected whether the motor vehicle 1, although stationary, is located on a turntable D. If it is detected that the motor vehicle 1 is located on a turntable D, the step 500 of disregarding or removing the ascertained yaw-rate measurement values G_{St}, which form or have a slope St, is carried out for ascertaining the yaw-rate offset value ω_{offset}. For the step 500 of ascertaining the yaw-rate offset value ω_{offset}, i.e., only the (remaining) yaw-rate measurement values Gᵥₑᵣ of the part of the yaw-rate measurement signal S_{ω} are used, in which the motor vehicle 1 is stationary but not rotating. This results in a more accurate determination or estimation of the yaw-rate offset value ω_{offset}.

In the schematic flow diagram of the exemplary embodiment of FIG. 4, a further optional (represented by a dashed line) step 600 of ascertaining a yaw-rate value is shown. The step of ascertaining in step 600 is based on the yaw-rate measurement signal S_{ω}, or the yaw-rate measurement values and the yaw-rate offset value ω_{offset} ascertained in step 500. A method is thus also optionally shown here for ascertaining the yaw-rate value ω, which comprises the previously described steps of the method for ascertaining the yaw-rate offset value ω_{offset}. The step 600 of ascertaining a yaw-rate value or the yaw rate is based on the yaw-rate measurement signal S_{ω} (or the yaw-rate measurement(s) over time) and the ascertained yaw-rate offset value ω_{offset}. In particular, this can be carried out by adjusting a real yaw-rate measurement value ωᵣₑₐₗ of the yaw-rate sensor 4 (or the most recent or currently actually measured yaw-rate value) by means of the ascertained yaw-rate offset value ω_{offset}. In other words, the ascertained yaw-rate offset value ω_{offset} can be subtracted or deducted from the real yaw-rate measurement value ωᵣₑₐₗ of the yaw-rate sensor 4 (or the most recent or currently actually measured yaw-rate value).

FIG. 5 shows a schematic flow diagram of a further exemplary embodiment of the method for ascertaining the yaw-rate offset value or the yaw-rate value. It is based on the exemplary embodiment described in FIG. 4. In addition, the method now includes one or more of steps 210, 220, 230, and 410 and 510. If it is then decided in FIG. 5 in step 200 that the motor vehicle 1 is stationary (branch Y for “Yes” at step 200 in FIG. 5), then the method proceeds to step 210, which compares the yaw-rate measurement signal S_{ω} (or the plurality of yaw-rate measurement values ω₁, . . . , ωₓ) with a threshold value ωₜₕ. In particular, each yaw-rate measurement value ω₁, . . . , ωₓ can be compared individually with the threshold value ωₜₕ. The threshold value ωₜₕ can have, in particular, a value of approximately or a maximum of 3°/s, in particular approximately or a maximum of 2.5°/s, in particular approximately 1°/s. The threshold value ωₜₕ can or should be below the constant yaw-rate measurement value ωₖₒₙₛₜ. The threshold value ωₜₕ can be in particular a predetermined or configured value, in particular depending on the respective yaw-rate sensor 4.

The step 210 can comprise in particular ascertaining relevant yaw-rate measurement values Gᵣₑₗ of the yaw-rate measurement signal S_{ω} which are below the threshold value ωₜₕ. In particular, for each yaw-rate measurement value ω₁, . . . , ωₓ it can be ascertained individually whether it is below the threshold value ωₜₕ. In particular, the relevant yaw-rate measurement values Gᵣₑₗ (below the threshold value ωₜₕ) may comprise the yaw-rate measurement values G_{St} which form or have a slope St, i.e. when the turntable starts to rotate or stops rotating.

With reference to FIG. 6, a diagram of a further exemplary yaw-rate measurement signal S_{ω} is shown. It is essentially based on the exemplary embodiment described in FIG. 3b. In addition, the threshold value ωₜₕ and the slope St are now shown. Also shown is or are the set of or the ascertained yaw-rate measurement values Gₛₜ which form a slope St, as well as the set of or the relevant yaw-rate measurement values Gᵣₑₗ of the yaw-rate measurement signal S_{ω} which are below the threshold value ωₜₕ. In the period from time t₁ to t₂, when the turntable D begins to rotate, the set of the (increasing) yaw-rate measurement values G_{St} which form a positive slope St is shown. In the period from time t₃ to t₄, when the turntable D stops rotating, the set of the (decreasing) yaw-rate measurement values G_{St} which form a negative slope St is shown. The set of the relevant yaw-rate measurement values Gᵣₑₗ of the yaw-rate measurement signal S_{ω}, which are below the threshold value ωₜₕ, is also shown. This set of relevant yaw-rate measurement values Gᵣₑₗ does not include the yaw-rate measurement values in the period t₂ to t₃ during which the turntable D rotates at a constant turntable speed, i.e. when the yaw-rate measurement values have an approximately constant value ωₖₒₙₛₜ, which is above the threshold value ωₜₕ and also above the yaw-rate offset value ω_{offset} of the yaw-rate sensor 4. Thus, the set of the remaining yaw-rate measurement values Gᵥₑᵣ can be defined or referred to as the set that results from the set of the relevant yaw-rate measurement values Gᵣₑₗ after deducting or disregarding or removing the set of the ascertained yaw-rate measurement values G_{St} that form a slope St. The remaining yaw-rate measurement values, or the set Gᵥₑᵣ thereof, can therefore be denoted in particular by Gᵥₑᵣ=Gᵣₑₗ−G_{St}, where Gᵣₑₗ indicates the relevant yaw-rate measurement values (below the threshold value), and G_{St} the yaw-rate measurement values that form a slope St.

Returning now to FIG. 5, if it is then ascertained in step 210 that or which relevant yaw-rate measurement values Gᵣₑₗ of the yaw-rate measurement signal S_{ω} are below the threshold value ωₜₕ (branch Y for “Yes” at step 210 in FIG. 5), then the method proceeds to step 220 of storing these ascertained yaw-rate measurement values as relevant yaw-rate measurement values Gᵣₑₗ. For example, the memory can be implemented as a ring buffer (e.g. maximum buffer length 20). The memory is in particular part of the control device 3 or directly connected to it. Only the valid or relevant yaw-rate measurement values Gᵣₑₗ that are possible for ascertaining the yaw-rate offset value are stored in the memory. Thus, only a set of valid or relevant yaw-rate measurement values Gᵣₑₗ is analyzed. However, it is not sufficient for the set of yaw-rate measurement values to be only below the threshold value ωₜₕ. A yaw-rate measurement value ω₁, . . . , ωₓ may be below a threshold value ωₜₕ, but be part of the turning or rotating motion of the turntable D, especially if the turntable D starts to rotate or stops rotating, and are therefore not permissible for ascertaining the yaw-rate offset value ω_{offset}. Therefore, the set G_{St} of the yaw-rate measurement values which form a slope St in the yaw-rate measurement signal S_{ω} is ascertained, as already described in step 300. Then, in step 400, this set G_{St} of the yaw-rate measurement values that form a slope St is disregarded or filtered out when ascertaining the yaw-rate offset value ω_{offset}. The step 300 of ascertaining yaw-rate measurement values Gₛₜ that form a slope St in the yaw-rate measurement signal is carried out on the basis of the ascertained relevant yaw-rate measurement values Gᵣₑₗ which are below the threshold value ωₜₕ, or by means of these values. The subsequent step 400 of disregarding the ascertained yaw-rate measurement values G_{St} that form a slope St then comprises removing (or filtering out) these values from the relevant yaw-rate measurement values Gᵣₑₗ, most importantly from the memory. Only the remaining yaw-rate measurement values G_{Ver} can then be used to ascertain the yaw-rate offset value ωₜₕ in step 500.

As can be seen in the exemplary embodiment of FIG. 5, however, before step 300 and 400, i.e. after step 220, a step 230 is also carried out to check whether a sufficient number of relevant ascertained yaw-rate measurement values Gᵣₑₗ is stored in the memory (e.g. between 10 and 20 values, or exactly 20 or 10 values). It is therefore checked whether there are enough relevant yaw-rate measurements available in the memory to carry out the determination of a slope St. After step 220, as described above, step 300 and then step 400 are executed.

In step 300 of ascertaining yaw-rate measurement values G_{St}, which form a slope St in the yaw-rate measurement signal, in particular, a (simple) linear regression can be formed with the relevant yaw-rate measurement values Gᵣₑₗ ascertained, e.g. with the last few yaw-rate measurement values Gᵣₑₗ in the memory (e.g. the last 3 or 4 yaw-rate measurement values Gᵣₑₗ in the memory). It can then be checked whether the slope St of the straight line thus determined is steep enough, e.g. whether this slope exceeds a slope threshold value (e.g. slope >5%). It is then possible to check which yaw-rate measurement values Gᵣₑₗ (in the memory) belong to this slope. These are then the yaw-rate measurement values G_{St} that form the slope St. These yaw-rate measurement values G_{St}, which belong to or form the slope St, are then disregarded in step 400. The other (remaining) yaw-rate measurement values G_{Ver}, which do not belong to the slope St, can then be used to ascertain the yaw-rate offset value ωₜₕ in step 500.

In addition, in the exemplary embodiment of FIG. 5, after step 400 a step 410 is carried out to check whether a sufficient number of ascertained and filtered yaw-rate measurement values are stored in the memory (e.g. between 10 and 20 values, or exactly 20 or 10 values). Only then can the yaw-rate offset value ω_{offset} be ascertained in step 500 thereafter. In step 410, it is therefore possible to check whether sufficient yaw-rate measurement values are stored or remain in the memory in order to calculate the yaw-rate offset value ω_{offset} in step 500 thereafter.

In step 500, the yaw-rate offset value ω_{offset} is then ascertained by means of or based on the yaw-rate measurement values G_{Ver} remaining in the memory. In particular, these remaining yaw-rate measurement values G_{Ver} can be the yaw-rate measurement values in the memory which result from the relevant yaw-rate measurement values Gᵣₑₗ after deducting or disregarding or removing the ascertained yaw-rate measurement values G_{St} that form a slope. Ascertaining the yaw-rate offset value ω_{offset} here can comprise in particular ascertaining the mean value of the remaining yaw-rate measurement values G_{Ver}. The mean value can be calculated in particular as the quotient of the sum of the remaining yaw-rate measurement values G_{Ver} and the number N of the remaining yaw-rate measurement values G_{Ver}. According to step 500, as described in relation to FIG. 3, the step 600 of ascertaining the yaw-rate value can also be carried out.

As can be seen in the exemplary embodiment of FIG. 5, however, here after step 500, a further step 510 of checking the plausibility of the yaw-rate offset value ω_{offset} ascertained in step 500 is carried out. The plausibility checking can comprise in particular checking whether the modulus or absolute yaw-rate offset value |ω_{offset}| is within a defined range B. The defined range B can be in particular in the range from 0.2 to 0.3°/s.

FIG. 7 shows a diagram of an exemplary yaw-rate measurement signal S_{ω} of a further exemplary embodiment. It is based substantially on the exemplary embodiment described in FIG. 6. In addition, a range B is now identified, which is used for step 510 of the plausibility check. The range B here is shown located between the zero line and a maximum value. However, the range B comprises in particular a range of plus/minus a defined value, e.g. plus/minus 0.3°/s, i.e. a total of 0.6°/s.

FIG. 8 shows a diagram of an actually measured yaw-rate measurement signal S_{ω} of a further exemplary embodiment. In the upper part of FIG. 8, the stationary signal (standstill) S_{standstill} is recorded against time. Initially the vehicle is moving, i.e. the speed v_{Ego} of the vehicle is non-zero, and accordingly the standstill signal S_{Standstill} initially has the value 0 (i.e. not stationary). Then, however, after a certain time, as can be seen in FIG. 8, the standstill signal S_{Standstill} has the value 1 or jumps up to it, i.e. the vehicle is then at a standstill or the speed v_{Ego} of the vehicle is zero. In the lower part of FIG. 8, the actually measured yaw-rate signal S_{ω}, i.e. the measured yaw-rate measurement values over time t, is plotted. Using the method described here, the yaw-rate offset value ω_{offset} is also correctly ascertained in a situation with a rotating turntable, as can be seen in FIG. 8.

1. A method for ascertaining a yaw-rate offset value that constitutes the offset of yaw-rate measurement values of a yaw-rate sensor of a motor vehicle, the method comprising:
receiving a plurality of yaw-rate measurement values from the yaw-rate sensor over time, said measurement values constituting a yaw-rate measurement signal;
checking whether the motor vehicle is stationary; and
if the motor vehicle is stationary, ascertaining the yaw-rate offset value on the basis of the yaw-rate measurement signal;
ascertaining yaw-rate measurement values which form a slope in the yaw-rate measurement signal; and
disregarding the ascertained yaw-rate measurement values which form a slope, for ascertaining the yaw-rate offset value.

2. The method as claimed in claim 1, wherein checking whether the motor vehicle is stationary comprises checking whether a speed of the motor vehicle is equal to or approximately zero and/or wheel pulses of the motor vehicle are equal to or approximately zero.

3. The method as claimed in claim 1, comprising comparing the yaw-rate measurement signal with a threshold value.

4. The method as claimed in claim 3, wherein the threshold value has a value of approximately or a maximum of 3°/s.

5. The method as claimed in claim 3, comprising ascertaining relevant yaw-rate measurement values of the yaw-rate measurement signal, which are below the threshold value.

6. The method as claimed in claim 5, wherein ascertaining yaw-rate measurement values which form a slope in the yaw-rate measurement signal is carried out on the basis of the ascertained relevant yaw-rate measurement values which are below the threshold value.

7. The method as claimed in claim 6, wherein disregarding the ascertained yaw-rate measurement values which form a slope comprises removing these values, which are below the threshold value, from the relevant yaw-rate measurement values.

8. The method as claimed in claim 1, wherein ascertaining the yaw-rate offset value comprises ascertaining the mean value of the remaining yaw-rate measurement values.

9. The method as claimed in claim 1, comprising plausibility checking the ascertained yaw-rate offset value.

10. The method as claimed in claim 9, wherein the plausibility checking comprises checking whether the ascertained yaw-rate offset value is within a defined range.

11. A method for ascertaining a yaw-rate value, comprising the method for ascertaining a yaw-rate offset value as claimed in claim 1, comprising ascertaining a yaw-rate value based on the yaw-rate measurement signal and the ascertained yaw-rate offset value.

12. A control device for ascertaining a yaw-rate offset value and/or a yaw-rate value, which is designed to carry out the method as claimed in claim 1.

13. A sensor device for a motor vehicle, having at least one yaw-rate sensor and having a control device as claimed in claim 12.

14. A computer program product having program code means that are stored in a computer-readable medium in order to carry out the method as claimed in claim 1 when the computer program product is run on a processor of an electronic control unit.

15. A motor vehicle having a sensor device as claimed in claim 13.
